(19) United States
(12) Patent Application Publication
(10) Pub. No.: US 2007/0151174 A1
(43) Pub. Date: Jul. 5, 2007

(54) Hurricane panel apparatus

(75) Inventor: Harold J. Osborne, Fort Lauderdale, FL (US)

Correspondence Address: BUCHANAN, INGERSOLL & ROONEY PC, POST OFFICE BOX 1404, ALEXANDRIA, VA, 22313-1404, US

(73) Assignee: Easy Hurricane Panels, LLC

(21) Appl. No.: 11/318,556

(22) Filed: Dec. 28, 2005

(51) Int. Cl. E06B 7/00

(52) U.S. Cl. 52/171.1

(57) ABSTRACT

A hurricane panel to protect a fragile portion of a building is disclosed, which includes an impact resistant multilayer panel having first and second (e.g., upper and lower) edges which are generally parallel to one another; and first and second (e.g., upper and lower) panel retaining members each configured for attachment to a building exterior, wherein the first and second edges of the multilayer panel are removably secured by the first and second panel retaining members, respectively, such that the multilayer panel is configured to be removably retained over a fragile portion of a building.

### BACKGROUND

A hurricane panel apparatus is disclosed to protect a fragile portion of a building, such as windows and glass doors, from being damaged or breeched by projectiles which may be propelled by high winds such as occur, for example, during a hurricane.

Hurricane panels and apparatus for attaching the same over windows and glass doors are known. Examples of hurricane panels for attachment to the exterior of buildings are described in U.S. Pat. Nos. U.S. Pat. No. 6,189,264 (DiVeroli), U.S. Pat. No. 4,333,271 (DePaolo et al.), U.S. Pat. No. 5,335,452 (Taylor), U.S. Pat. No. 5,522,445 (Hoffman), U.S. Pat. No. 3,528,196 (Luke), U.S. Pat. No. 6,148,895 (Biggers), and U.S. Patent Application Publication No. US 2002/0162286 A1 (Heissenberg). The hurricane panels described are made of, for example, metal plates, corrugated metal panels, and wood. Additionally, U.S. Pat. No. 6,260,329 (Mills) describes a lightweight building panel. These building panels are described as lightweight modular structural panels which are disposed in parallel along the inside face of a wall, i.e., facing indoors.

Attachments for holding the hurricane panels to the exterior of the building include h-tracks, j-hangers, accordion type, roll-open type, screws, and cross-bar structures.

### SUMMARY

A hurricane panel to protect a fragile portion of a building is disclosed, which comprises an impact resistant multilayer panel having first and second (e.g., upper and lower) edges which are generally parallel to one another; and first and second (e.g., upper and lower) panel retaining members each configured for attachment to a building exterior, wherein the first and second edges of the multilayer panel are removably secured by the first and second panel retaining members, respectively, such that the multilayer panel is configured to be removably retained over a fragile portion of a building.

A hurricane panel is disclosed to protect fragile portions of a building, such as windows and glass doors, from being damaged or breeched by projectiles which may be propelled by high winds such as occur, for example, during a hurricane, the hurricane panel comprising an impact resistant multilayer panel securable to the exterior of the building over the fragile portions thereof, and wherein the multilayer panel has a core layer of lightweight material sandwiched between impact resistant outer layers.

### BRIEF DESCRIPTION OF THE DRAWING FIGURES

A more complete understanding of the exemplary embodiments can be obtained by considering the following detailed description in conjunction with the accompanying drawings, in which:

FIG. 1 is a front view of an embodiment of a multilayer hurricane panel;

FIG. 2 is a cross section view taken along line II-II in FIG. 1;

FIG. 3 is a front view of an embodiment of a hurricane panel apparatus according to the invention;

FIG. 4 is a cross section view taken along line IV-IV in FIG. 3;

FIG. 5 is a cross section view of an embodiment of the hurricane panel apparatus as it may be installed covering a window; and

FIG. 6 is a cross section view of another embodiment of the hurricane panel apparatus as it may be installed covering a glass door.

### DETAILED DESCRIPTION OF CERTAIN EMBODIMENTS

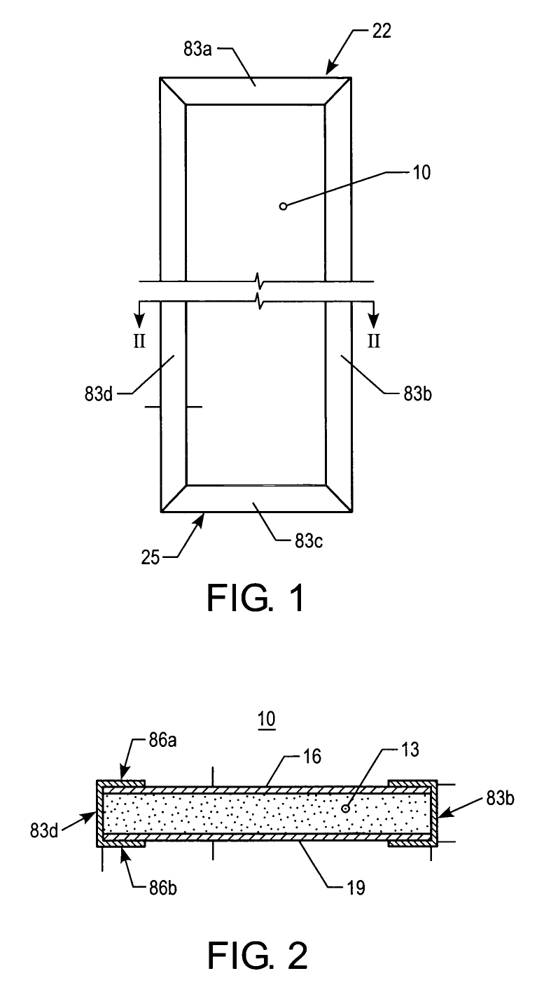

An impact resistant means represented as a multilayer panel 10 of a hurricane panel is illustrated in FIGS. 1 and 2, comprising a core layer 13 of lightweight material which is sandwiched between impact resistant outer layers 16, 19. As referenced herein, a “hurricane panel” is any panel configured as a device for protecting against damage due to forces such as wind (such as hurricane force winds on the order of 30 mph, or fewer or greater), or other similar forces of any origin which could cause similar damage as can be caused by wind, or by the effects thereof (e.g., projectiles which become airborne by wind or other force). The lightweight core material 13 can be an expanded polystyrene material, e.g., Styrofoam and the impact resistant outer layers 16, 19 can be metal. However, one of ordinary skill in the art would understand that other types of lightweight core materials other than expanded polystyrene could be used, and that other types of impact resistant outer layers could be employed. For example, a moldable copolymer foam or other lightweight materials could be used as the lightweight core material. Similarly, for example, a suitable type of fiberglass, plastic, or other material, properly designed to have the appropriate impact resistant characteristics, could be used as the outer layers.

In a first embodiment, the multilayer panel 10 has a thickness of about 2 inches, the lightweight core material 13 is Styrofoam having a density of about 2 lb/ft³, and the impact resistant outer layers 16, 19 are aluminum having a thickness of about 0.030 inch. The outer layers are glued to the lightweight core layer using any suitable adhesive. The exterior surface of the metal outer layers 16, 19 can be painted, adding about 0.002 inch of additional thickness to each outer layer 16, 19. The multilayer panel 10 can be any commercially available panel having any of different overall thicknesses, densities of the expanded polystyrene core material 13, and thicknesses and types of metal used as the outer layers 16, 19. The multilayer panels 10, 11 can be made by adhering the outer layers 16, 19 of metal to the expanded polystyrene core 13 using appropriate adhesives. Suitable panels can be purchased from, for example, Elite Aluminum Corp., 4650 Lyons Technology Pkwy Coconut Creek, Fla. 33073.

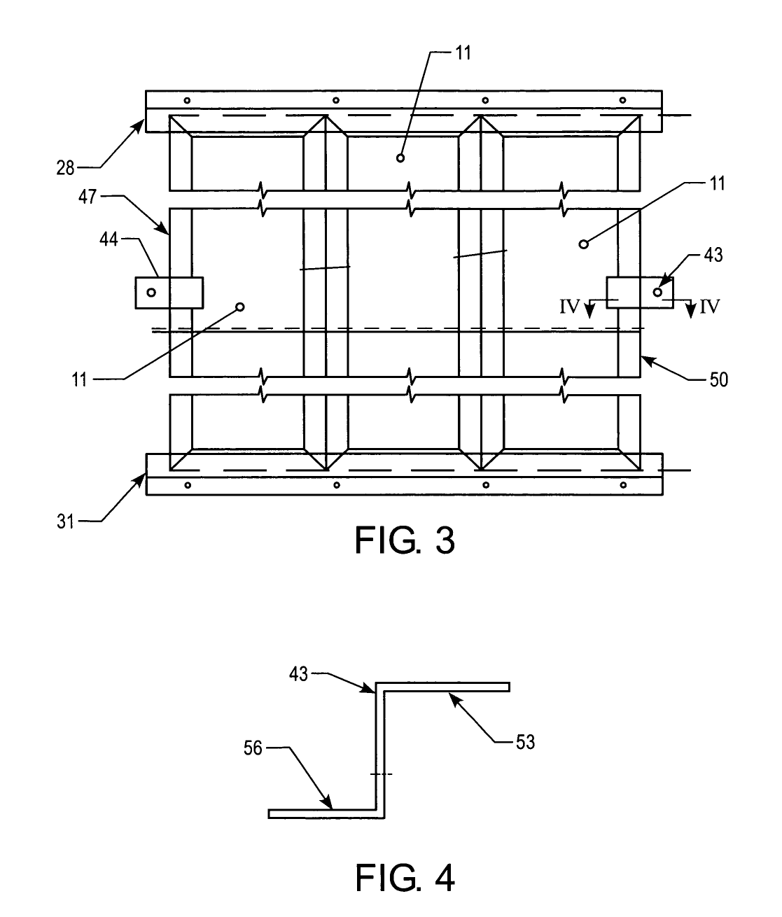

Referring to FIG. 3, a front view of an embodiment of a hurricane panel is illustrated as it would appear installed onto the exterior of a building to protect fragile portions of the building, such as windows and glass doors, from being damaged or breeched by projectiles which may be propelled by high winds such as occur, for example, during a hurricane, tropical storm, or tornado. The multilayer panels 10 can be provided in various sizes, such that a single multilayer panel 10 could be provided to cover entire windows or glass doors. However, as shown in the figure, multiple smaller multilayer panels 11 can be provided to cover a single window or glass door. The use of multiple smaller multilayer panels 11 enable standardization of sizes and resulting lower cost, such that custom sized panels would not need to be manufactured for different sizes of windows and glass doors.

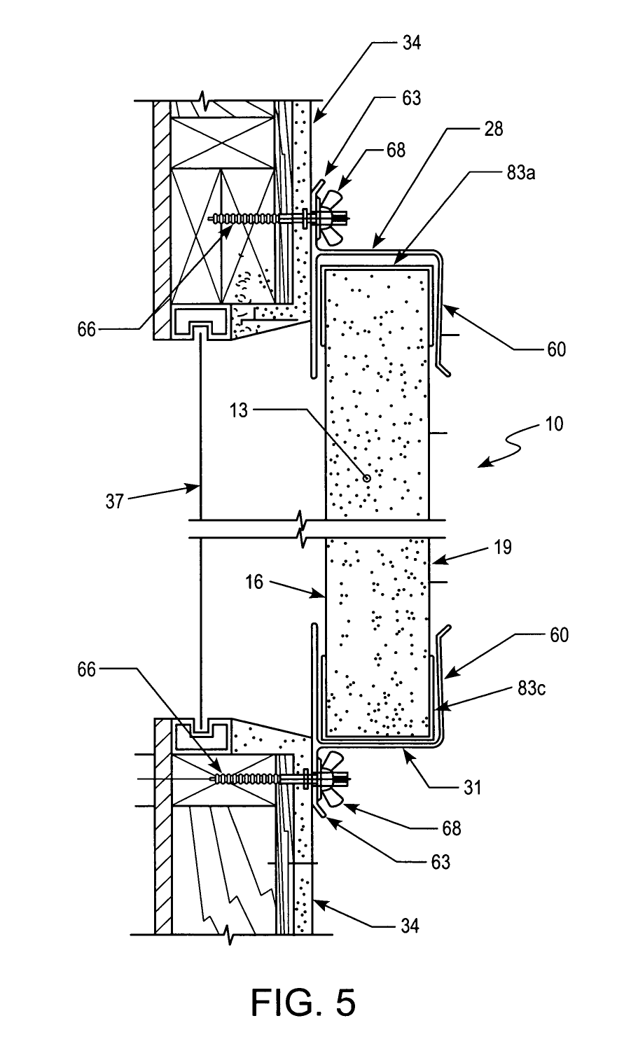

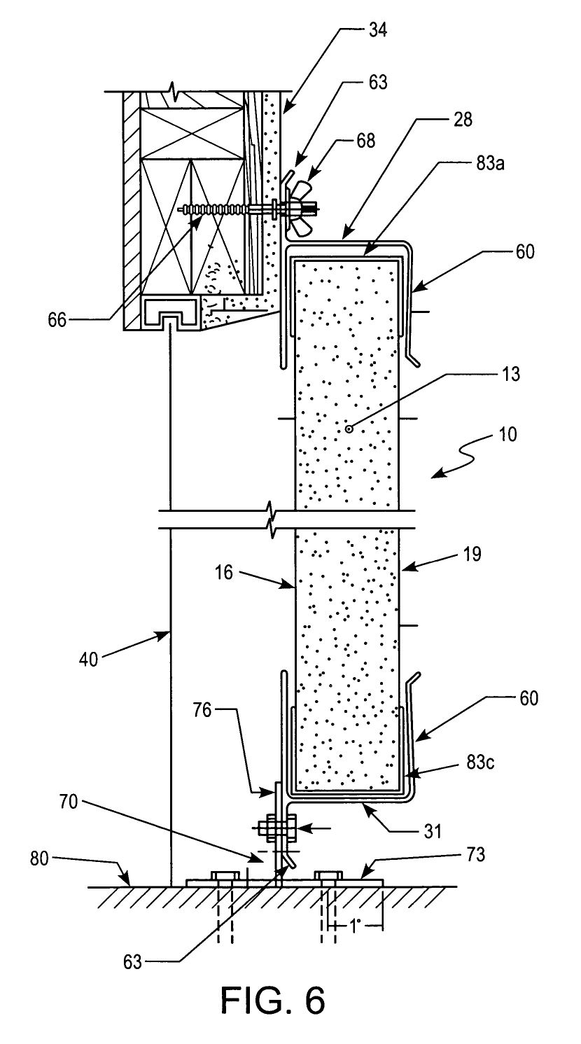

Each of the impact resistant multilayer panels 10, 11 have upper and lower, or first and second, generally parallel edges 22, 25 (i.e., edges parallel to one another) which are removably secured over the fragile portions of the building by corresponding upper and lower, or first and second, panel retaining members 28, 31. The upper and lower panel retaining members 28, 31 are each attachable to the exterior 34 of a building adjacent the windows 37 and glass doors 40 (shown in FIGS. 5 and 6).

The hurricane panel can include a means for attaching represented as a pair of clip members, for example Z-shaped clips 43, 44, which can be specifically configured as complementary attachments at left-most and right-most, or third and fourth, edges 47, 50, respectively, of left-most and right-most ones of the multilayer panels 11. Where a single large multilayer panel is used the clips 43, 44 hold the left and right edges of the panel 11. The clips 43, 44 help to hold the multilayer panels 10, 11 against the exterior building, which can minimize the possibility of the multilayer panels 10, 11, and the panel retaining members 21, 28, being ripped away from the building by wind. The clip members 43, 44 can also prevent the multilayer panels 10, 11 from inadvertently sliding out of engagement with the panel retaining members 21, 28.

As shown in FIG. 4, each clip member 43, 44 can be configured as a Z-shaped flange having a first portion 53 securable to the exterior of a building and an opposite portion 56 engageable over a respective complementary edge of the end-most ones of the multilayer panels 11. The first portion 53 of the flange can be attached to the building exterior in any known, suitable manner. The manner of attachment enables easy removal of the clip members 43, 44 so that the multilayer panels 11 can be conveniently removed when no longer needed, if desired.

As shown in FIGS. 5 and 6, each of the panel retaining members 28, 31 can have an h-shaped cross section defining a channel portion 60 and a flange portion 63 extending from the channel portion 60. The flange portion 63 of each h-shaped panel retaining member 28, 31 can be configured to be attachable to the exterior of the building with the channel portions 60 facing each other. In this manner, the upper and lower edges 22, 25 of the multilayer panels 10, 11 can be slidably secured in the channel portions 60. This facilitates quick and easy installation and removal of the multilayer panels 10, 11, to cover windows 37 or doors 40, by simply sliding the panels 10, 11 in and out of the channels 60.

In FIG. 5, and the top attachment in FIG. 6, the flanges 63 are shown attached to the exterior of the building using screws 66 and wing-nuts 68, or other suitable attachment means. The use of wing-nuts 68 enable easy removal of the panel retaining members 28, 31, if desired. The panel retaining members 28, 31 can be configured to create an attractive appearance on the outside of the building, and thus may be left attached to the building even when the impact resistant multilayer panels 10, 11 are removed.

Additionally, this means of attachment using screws 66 is suitable to, for example, wood buildings. Alternative means of attachment, such as to block or concrete buildings, could utilize concrete anchors or other suitable fasteners. However, such fasteners can be chosen to permit easy removal of the panel retaining members 28, 31 when desired.

As illustrated in the lower portion of FIG. 6, an angle member 70 can be provided where the hurricane panel is used to cover a glass door 40, or perhaps a window located near ground level. The angle member 70 has a first leg 73 for fixing the angle member in place and a second leg 76 to which the lower panel retaining member 31 is attached. The first leg 73 can be a generally horizontal flange portion which is attachable to a generally horizontal surface 80 adjacent the bottom of the glass door 40, or low window, such as a wood or composite deck, a patio, or possibly the ground using an appropriate anchor. The second leg 76 can be a generally vertical flange portion to which is attached the flange portion 63 of the lower retaining member 31.

The attachment of the angle member 70 to both the horizontal surface 80 and the lower panel retaining member 31 can be accomplished using fasteners which permit easy detachment thereof, so that the lower panel retaining member 31 and the angle member 70 can be easily removed when desired.

In other embodiments of the multilayer panel 10, edge stiffeners 83a-83d, seen best in FIG. 2, can be provided which can be placed over each edge of the impact resistant multilayer panels 10, 11. Each edge stiffener 83a-83d can be, for example, a thin walled metal channel. Additionally, the sides 86a, 86b of the metal channel can be angled inwardly towards each other so as to frictionally grip the edges of the multilayer panels 10, 11. The edge stiffeners can be glued to the multilayered panels to prevent inadvertently becoming dislodged. In addition to adding strength and stiffness to the multilayer panels 10, 11, the edge stiffeners 83a-83d can cover sharp edges of the multilayer panels 10, 11 which can result when the panels are cut to the desired size. The edge stiffeners 83a-83d can also provide a more aesthetic, finished appearance to the multilayer panels 10, 11.

Although certain embodiments of the hurricane panel apparatus have been described in detail, it will be appreciated by those skilled in the art that various modifications to those details could be developed in light of the overall teaching of the disclosure. Accordingly, the particular embodiments disclosed herein are intended to be illustrative only and not limiting to the scope of the hurricane panel apparatus which should be awarded the full breadth of the following claims and any and all embodiments thereof.

What is claimed is:

1. A hurricane panel to protect a fragile portion of a building, comprising:
an impact resistant multilayer panel having first and second edges which are generally parallel to one another; and
first and second panel retaining members each configured for attachment to a building exterior, wherein the first and second edges of the multilayer panel are removably secured by the first and second panel retaining members, respectively, such that the multilayer panel is configured to be removably retained over a fragile portion of a building.

2. The hurricane panel of claim 1, wherein the multilayer panel has third and fourth edges which are generally parallel to one another, the hurricane panel comprising:
a pair of clip members each having one end securable said exterior of said building and an opposite end attachable to a respective one of said third and fourth edges.

3. The hurricane panel of claim 2, wherein each of said first and second retaining members have an h-shaped cross section defining a channel portion and a flange portion extending from the a channel portion, said flange portion being attachable to said exterior of said building with said channel portions facing each other; and
wherein said first and second edges of the multilayer panel are slidably received in the channel portion of said first and second channels, respectively.

4. The hurricane panel of claim 3 comprising:
an angle member having a first leg attachable to a surface adjacent said fragile portion of said building, and a second leg attachable to said flange portion of said at least one of said first and second retaining members.

5. The hurricane panel of claim 1 wherein said multilayer panel comprises a core layer of lightweight material sandwiched between of impact resistant outer layers.

6. The hurricane panel of claim 5 wherein said lightweight core layer comprises an expanded polystyrene material.

7. The hurricane panel of claim 5 wherein said impact resistant outer layers are metal.

8. The hurricane panel of claim 5 wherein said multilayer panel has a thickness of about 2 inches, said lightweight material is Styrofoam™ having a density of about 2 lb/ft³, and said layers of impact resistant outer layers are aluminum having a thickness of about 0.030 inch.

9. The hurricane panel of claim 2, comprising:
an edge stiffener covering each of said first, second, third and fourth edges of said multilayer panel.

10. The hurricane panel of claim 8, wherein said edge stiffener comprises:
a channel, and said channel having sides angled inwardly towards each other so as to frictionally grip said first, second, third and fourth edges of said multilayer panel.

11. The hurricane panel of claim 1, wherein said multilayer panel comprises:
a plurality of multilayer panels secured over said fragile portions of said building.

12. A hurricane panel to protect fragile portions of a building, such as windows and glass doors, from being damaged or breeched by projectiles which may be propelled by high winds such as occur, for example, during a hurricane, the hurricane panel comprising an impact resistant multilayer panel securable to the exterior of the building over the fragile portions thereof, and wherein said multilayer panel has a core layer of lightweight material sandwiched between impact resistant outer layers.

13. The hurricane panel of claim 12, wherein said lightweight core layer comprises:
an expanded polystyrene material.

14. The hurricane panel of claim 12, wherein said impact resistant outer layers are metal.

15. The hurricane panel of claim 12, wherein the multilayer panel has a thickness of about 2 inches, the lightweight material is Styrofoam™ having a density of about 2 lb/ft³, and each of said impact resistant outer layers are aluminum having a thickness of about 0.030 inch.

16. The hurricane panel of claim 1, comprising:
an edge stiffener covering outer edges of said multilayer panel.

17. The hurricane panel of claim 16, wherein said edge stiffener comprises:
a channel, and said channel having sides angled inwardly towards each other so as to frictionally grip said outer layers of said multilayer panel.
